(19) United States
(12) Patent Application Publication
(10) Pub. No.: US 2005/0119437 A1
(43) Pub. Date: Jun. 2, 2005

(54) Polyurethane powder coatings which contain solid polyaddition compounds containing uretdione groups and a process for their preparation

(75) Inventors: Andreas Wenning, Nottuln (DE); Emmanouil Spyrou, Dorsten (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/961,030

(22) Filed: Oct. 12, 2004

(30) Foreign Application Priority Data
Oct. 15, 2003 (DE) 10347901.5

(51) Int. Cl. C08G 18/00

(52) U.S. Cl. 528/44

(57) ABSTRACT

The invention relates to polyurethane powder coatings which comprise solid polyaddition compounds containing uretdione groups and to a process for their preparation. The polyurethane powder coatings cure at low temperatures and form paint films which are high gloss or matt and light- and weather-stable.

### BACKGROUND OF THE INVENTION

1. Field of the Invention

The invention relates to solid polyurethane powder coating compositions which comprise solid polyaddition compounds containing uretdione groups, to a process for their preparation, to a process for preparing a coating from the compositions and to coatings derived therefrom.

2. Description of the Related Art

Externally or internally blocked polyisocyanates which are solid at room temperature are useful as crosslinkers for thermally crosslinkable polyurethane (PU) powder coating compositions.

For example, U.S. Pat. No. 4,246,380 describes PU powder coatings featuring outstanding weathering stability and thermal stability. The crosslinkers whose preparation is described in U.S. Pat. No. 4,302,351 are composed of isophorone diisocyanate which contains isocyanurate groups and is blocked with E-caprolactam. Also known are polyisocyanates which contain urethane, biuret or urea groups and whose isocyanate groups are likewise blocked.

The disadvantage of these externally blocked systems lies in the elimination of the blocking agent during the thermal crosslinking reaction. Since the blocking agent may thus be emitted into the environment, it is necessary on environmental and occupational hygiene grounds to take special measures to clean the outgoing air and/or to recover the blocking agent. Moreover, the reactivity of the crosslinkers is low. Curing temperatures above 170° C. are required.

U.S. Pat. No. 4,463,154 and U.S. Pat. No. 4,483,789 describe processes for preparing polyaddition compounds which contain uretdione groups and whose terminal isocyanate groups are irreversibly blocked with monoalcohols or monoamines. A particular disadvantage are the chain-terminating constituents of the crosslinkers, which lead to low network densities in the PU powder coatings and thus to moderate solvent resistances.

Uretdione powder coating crosslinkers prepared by reacting polyisocyanates containing uretdione groups with diols and with chain extenders containing ester groups and/or carbonate groups, or using dimer diols, are described in U.S. Pat. No. 5,621,064 and in U.S. Pat. No. 5,596,066.

Hydroxyl-terminated polyaddition compounds containing uretdione groups are subject matter of U.S. Pat. No. 6,631,861. On the basis of their functionality of two they exhibit improved resistance to solvents.

A common feature of the powder coating compositions based on these polyisocyanates containing uretdione groups is that they do not emit any volatile compounds in the course of the curing reaction. However, the at least 180° C. baking temperatures are high.

The use of amidines as catalysts in PU coating powder compositions is described in U.S. Pat. No. 5,847,044. Although these catalysts lead to a reduction in the curing temperature, they exhibit a considerable yellowing, which is generally unwanted in the coatings field. The cause of this yellowing is probably the reactive nitrogen atoms in the amidines. These atoms can react with atmospheric oxygen to give N-oxides, which are responsible for the discoloration.

U.S. Pat. No. 5,847,044 also mentions other catalysts which have been used to date for this purpose, but without showing any particular effect on the curing temperature. They include the organometallic catalysts known from polyurethane chemistry, such as dibutyltin dilaurate (DBTL), or else tertiary amines, such as 1,4-diazabicyclo[2,2,2]-octane (DABCO), for example.

WO 00/34355 claims catalysts based on metal acetylacetonates, an example being zinc acetylacetonate. Such catalysts are in fact able to lower the curing temperature of polyurethane powder coating compositions containing uretdione groups, but as reaction products give primarily allophanates (M. Gedan-Smolka, F. Lehmann, D. Lehmann “New catalysts for the low temperature curing of uretdione powder coatings” International Waterborne, High solids and Powder Coatings Symposium, New Orleans, Feb. 21-23, 2001). Allophanates are the reaction products of one mole of alcohol and two moles of isocyanate, whereas in the conventional urethane chemistry one mole of alcohol reacts with one mole of isocyanate. As a result of the unwanted formation of allophanates, therefore, isocyanate groups valuable both technically and economically are destroyed.

DE 103 20 267, U.S. 2003/0153713, and DE 103 20 266 describe metal hydroxides, metal alkoxides, quaternary ammonium salts with hydroxides, fluorides or carboxylates which accelerate the unblocking of uretdione groups so vigorously that when powder coating hardeners containing uretdione groups are used it is possible to achieve a considerable reduction in the curing temperature of powder coating compositions.

A problem common to all coatings produced from such highly accelerated powder coating compositions is that their surfaces exhibit severe orangepeel effects or even exhibit structures.

### SUMMARY OF THE INVENTION

Accordingly, it is one object of the present invention to prepare new highly reactive polyurethane powder coating compositions which cure at very low temperatures and form powder coatings which are high gloss or matt and are light- and weather-stable, with good leveling.

Surprisingly it has been found that polyaddition compounds containing uretdione groups, prepared from dodecane-1,12-diol may be used as a crosslinker component for polyurethane powder coating materials which can be cured at very low temperatures and whose films exhibit good leveling.

### DETAILED DESCRIPTION OF THE DRAWINGS

One aspect the invention provides highly reactive polyurethane powder coating compositions containing

I at least one solid polyaddition compound containing uretdione groups, obtained by reacting
A) from 40% to 90% by mass of at least one aliphatic, (cyclo)aliphatic or cycloaliphatic polyisocyanate component composed of
   1. at least 40% by mass of a polyisocyanate compound containing uretdione groups and having an average functionality of at least 2.0 and
   2. not more than 60% by mass of at least one diisocyanate compound and/or isocyanurate compound without uretdione groups;
B) from 60% to 10% by mass of dodecane-1,12-diol;
C) from 50% to 0% by mass of at least one further compound having at least one hydroxyl group;
   said polyaddition compounds having a melting point of from 40 to 130° C., a free NCO content of less than 5% by weight, and a uretdione content of from 6 to 18% by weight;

II at least one hydroxyl-containing polymer having a melting point of from 40 to 130° C. and an OH number of between 20 and 200 mg KOH/g;

III at least one catalyst selected from the group consisting of metal acetylacetonates, metal hydroxides, metal alkoxides, and quaternary ammonium salts with hydroxides, fluorides or carboxylates;

the ratio of the two components I and II being such that for each hydroxyl group of component II there is from 0.3 to 1 uretdione group of component I, and the fraction of the catalyst III being from 0.001 to 3% by weight of the total amount of components I and II.

The invention further provides a process for preparing highly reactive polyurethane powder coating compositions containing

I at least one solid polyaddition compound containing uretdione groups, obtained by reacting
A) from 40% to 90% by mass of at least one aliphatic, (cyclo)aliphatic or cycloaliphatic polyisocyanate component composed of
   1. at least 40% by mass of a polyisocyanate compound containing uretdione groups and having an average functionality of at least 2.0 and
   2. not more than 60% by mass of at least one diisocyanate compound and/or isocyanurate compound without uretdione groups;
B) from 60% to 10% by mass of dodecane-1,12-diol;
C) from 50% to 0% by mass of at least one further compound having at least one hydroxyl group;
   said polyaddition compounds having a melting point of from 40 to 130° C., a free NCO content of less than 5% by weight, and a uretdione content of from 6 to 18% by weight;

II at least one hydroxyl-containing polymer having a melting point of from 40 to 130° C. and an OH number of between 20 and 200 mg KOH/g;

III at least one catalyst selected from the group consisting of metal acetylacetonates, metal hydroxides, metal alkoxides, and quaternary ammonium salts with hydroxides, fluorides or carboxylates;

IV if desired, at least one compound which is reactive toward acid groups and whose weight fraction, based on the total formulation, is from 0.1 to 10%;

the ratio of the two components I and II being such that for each hydroxyl group of component II there is from 0.3 to 1 uretdione groups of component I, and the fraction of the catalyst III being from 0.001 to 3% by weight of the total amount of components I and II, where the process includes mixing the above-mentioned components and is carried out in a heatable apparatus with an upper temperature limit of 120 to 130° C.

The high-reactivity polyurethane powder coating compositions of the invention comprise essentially the polyaddition compounds I containing uretdione groups in combination with at least one hydroxyl-containing polymer II, at least one catalyst III, if desired, at least one compound which is reactive toward acid groups, and, if desired, auxiliaries and additives. The coating compositions may be free of other components that affect the properties of films derived from the coating compositions.

The polyisocyanates A1) containing uretdione groups that may be used to prepare the coating compositions may be obtained from any diisocyanates by catalytic dimerization of the isocyanate groups. Diisocyanates for preparing the starting compounds A1) include aliphatic, cycloaliphatic, araliphatic and/or aromatic diisocyanates. Preferred examples include 1,6-diisocyanatohexane (HDI), 2-methyl-pentamethylene 1,5-diisocyanate (DI 51), 2,2,4-(2,4,4)-trimethylhexamethylene diisocyanate, 4,4′-diisocyanatodicyclohexylmethane, 1,3- and 1,4-diisocyanato-cyclohexane, isophorone diisocyanate (IPDI), diphenylmethane 2,4′- and/or 4,4′-diisocyanate, xylylene diisocyanate or 2,4- and 2,6-tolylene diisocyanate, and any desired mixtures of these isomers, it being possible for these diisocyanates to be used alone or in mixtures to prepare component A). The polyisocyanates containing uretdione groups can be also be mixed arbitrarily with one another.

Suitable catalysts for preparing the starting compounds A1) from the aforementioned diisocyanates include in principle all known compounds which catalyze the dimerization of isocyanate groups. Examples are tertiary organic phosphines (U.S. Pat. No. 4,614,785, DE 19 34 763, and U.S. Pat. No. 4,994,541, tris(dialkylamino)phosphines (U.S. Pat. No. 4,476,054, U.S. Pat. No. 4,668,780, and U.S. Pat. No. 4,929,724), substituted pyridines (DE 10 81 895 and U.S. Pat. No. 4,912,210), and substituted imidazoles or benzimidazoles (U.S. Pat. No. 5,229,003) (each of which is incorporated herein by reference).

Preferred starting compounds A1) for the process of the invention are polyisocyanates containing uretdione groups that have been prepared from diisocyanates containing aliphatically and/or cycloaliphatically attached isocyanate groups. Particular preference is given to using the uretdiones of isophorone diisocyanate (IPDI) and of 1,6-diisocyanatohexane (HDI).

The isocyanurate-free uretdione of isophorone diisocyanate may be of high viscosity at room temperature, (e.g., more than 10⁶ mPa s); at 60° C. the viscosity may be 13×10³ mPa s and at 80° C. it may be 1.4×10³ mPa s. The free NCO content may be from 16.8% to 18.5% by mass, meaning that there must be more or less high fractions of IPDI polyuretdione in the reaction product. The monomer content may be 1% by mass. The total NCO content of the reaction product after heating at from 180 to 200° C. is preferably from 37.5% to 37.8% by weight.

In the course of the dimerization of aliphatic diisocyanates in conventional processes and with conventional catalysts, isocyanurate by-product may be formed in different amounts so that the NCO functionality of the isocyanurate-containing polyisocyanate uretdiones employed is preferably at least 2.

The diisocyanates A2) include the diisocyanates indicated above that are suitable for preparing component A1). They may account for up to 60% by weight of the total of starting compounds A1) and A2). Examples of suitable mixtures also include solutions of uretdiones in diisocyanates, such as are obtained following catalytic dimerization where the unreacted diisocyanate is not separated off.

The isocyanurates A2) are preferably the trimers of the diisocyanates also used to prepare the polyisocyanate compounds A1) containing uretdione groups. The isocyanurates can be added separately to the polyisocyanate compound A1) or else are already a part of the polyisocyanate compound A1), since in some cases they are formed during the dimerization of diisocyanates as a byproduct.

IPDI and/or HDI and the corresponding isocyanurates are preferably contained in component A2).

Suitable compounds C) include all monools, diols or polyols which are commonly employed in PU chemistry and whose molecular weight is at least 32.

In the case of the monoalcohols examples include methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, the isomeric methylcyclohexanols, and hydroxymethyl-cyclohexane.

In the case of the diols examples include ethylene glycol; triethylene glycol, butane-1,4-diol, pentane-1,5-diol, hexane-1,6-diol, 3-methylpentane-1,5-diol, neopentyl glycol, 2,2,4(2,4,4)-trimethylhexanediol, and neopentyl glycol hydroxypivalate.

In the case of the triols examples include trimethylolpropane, ditrimethylolpropane, trimethylolethane, hexane-1,2,6-triol, butane-1,2,4-triol, tris((3-hydroxyethyl) isocyanurate, pentaerythritol, mannitol, and sorbitol.

Also suitable are diols or polyols containing further functional groups. These include the conventional hydroxyl-containing polyesters, polycarbonates, polycaprolactones, polyethers, polythioethers, polyesteramides, polyurethanes or polyacetals. They preferably possess a number-average molecular weight of from 134 to 3,500.

The monools, diols or polyols may be used alone or in mixtures.

The polyaddition products I containing uretdione groups may be obtained in accordance with the process described as follows.

The reaction in solvent preferably takes place in general at temperatures from 50 to 100° C., more preferably between 60 and 90° C. The hydroxyl-bearing components B) and, where appropriate, C) may be introduced initially and the polyaddition compound A) containing uretdione groups is preferably added as rapidly as possible without the reaction temperature exceeding the limits specified above. The starting compounds B) and C) can alternatively be introduced together or reacted in any order, individually or in a mixture, in succession, with the polyaddition compound A) containing uretdione groups. When reaction has taken place, the solvent is removed. Suitable means for that purpose include evaporation screws, film extruders and spray driers.

Suitable solvents include benzene, toluene or other aromatic and/or aliphatic hydrocarbons, acetic esters, such as ethyl acetate or butyl acetate, and ketones, such as acetone, methyl ethyl ketone, and methyl isobutyl ketone, or chlorinated aromatic and aliphatic hydrocarbons, and also any desired mixtures of these or other inert solvents.

The solvent-free, continuous preparation of the polyaddition products I of the invention containing uretdione groups may be carried out by means of intensive kneading apparatus in a single-screw or multi-screw extruder, in particular in a twin-screw extruder, planetary roll extruder or annular extruder. The solvent-free synthesis is preferably carried out at temperatures of 110 to 190° C., which are already well within the unblocking range for uretdione groups. The short reaction times of <5 minutes, preferably <3 minutes, in particular <2 minutes have proven advantageous here. The brief thermal exposure is enough to provide homogeneous mixing of the reactants with substantial or complete reaction. Thereafter, controlled cooling is carried out in accordance with the setting of an equilibrium and, if necessary, the conversion is completed.

The reaction products may be supplied to the reaction/kneading apparatus in separate product streams, it being possible for the starting components to be preheated to up to 120° C., preferably to 90° C. Where there are more than two product streams they can also be metered or added in bundled form. Starting compounds B) and/or C) and/or catalysts and/or further customary coatings adjuvants, such as leveling agents and/or stabilizers, may be assembled into one product stream.

It is likewise possible to vary the sequence of the product streams and for the entry point of the product streams to be different.

Subsequent reaction, cooling, comminuting, and bagging may be performed using known techniques and technologies.

In order to accelerate the polyaddition reaction it is also possible to use catalysts customary in PU chemistry. They may be employed in a concentration of from 0.01% to 2% by weight, preferably from 0.03% to 0.5% by weight, based on the reaction components used. Examples of catalysts include tertiary amines, such as triethylamine, pyridine or N,N-dimethylaminocyclohexane, or metal salts, such as iron(III) chloride, molybdenum glycolate, and zinc chloride. Tin(II) and tin(IV) compounds have proven especially suitable. Particular mention may be made here of dibutyltin dilaurate (DBTL) and tin octoate.

In the case of the hydroxyl-containing polymers II it is preferred to use polyesters, polyethers, polyacrylates, polyurethanes and/or polycarbonates having an OH number of from 20 to 200 (in mg KOH/g). Particular preference is given to using polyesters having an OH number of from 30 to 150, a number average molecular weight of from 500 to 6,000 g/mol, and a melting point of between 40 and 130° C. Such binders have been described in, for example, EP 0 669 354 and EP 0 254 152 (both of which are incorporated herein by reference). Mixtures of such polymers can also be used. The amount of the hydroxyl-containing polymers is chosen such that for each hydroxyl group of the polymer there is from 0.3 to 1 uretdione group of the polyaddition compound of the invention that contains uretdione groups.

Catalysts III which can be used to accelerate the crosslinking reaction of the polyaddition compound containing uretdione groups with the hydroxyl-containing polymer are metal acetylacetonates, metal hydroxides, metal alkoxides or quaternary ammonium salts with hydroxides, fluorides or carboxylates. They are described in, for example, WO 00/34355, DE 103 20 267, U.S. 2003/0153713 and DE 103 20 266 (each of which is incorporated herein by reference).

Based on the total amount of the polyaddition compound of the invention containing uretdione groups and the hydroxyl-containing polymer, the fraction of the catalyst is preferably from 0.001% to 3% by mass.

The activity of these catalysts decreases significantly in the presence of acids. The conventional reaction partners for polyaddition compounds containing uretdione groups include hydroxyl-containing polyesters. Owing to the way in which these polyesters are prepared, they occasionally may still carry acid groups to a minor extent. The acid group content of the polyesters is preferably below 20 mg KOH/g, since otherwise the catalysts are excessively inhibited. In the presence of such polyesters which carry such acid groups it is appropriate either to use the aforementioned catalysts in excess, relative to the acid groups, or else to add reactive compounds capable of scavenging acid groups. Both monofunctional and polyfunctional compounds may be used for this purpose. The possible crosslinking effect of the polyfunctional compounds, although undesirable because of its viscosity-increasing effect, generally is not disruptive, owing to the low concentration.

Reactive acid-scavenging compounds IV include those of common knowledge in paint chemistry. For example, epoxy compounds, carbodiimides, hydroxylalkylamides or else 2-oxazolines react with acid groups at elevated temperatures. Suitable examples include triglycidyl ether isocyanurate (TGIC), Epikote® 828 (diglycidyl ether based on bisphenol A, Schell), Versatic acid glycidyl esters, ethylhexyl glycidyl ether, butyl glycidyl ether, Polypox R 16 (pentaerythritol tetraglycidyl ether, UPPC AG), Vestagon EP HA 320 (hydroxyalkylamide, Degussa AG), and also phenylenebisoxazoline, 2-methyl-2-oxazoline, 2-hydroxyethyl-2-oxazoline, 2-hydroxypropyl-2-oxazoline and 5-hydroxypentyl-2-oxazoline. Mixtures of such substances are also suitable. These reactive compounds may be used in weight fractions of from 0.1 to 10%, preferably from 0.5 to 3%, based on the total weight of formulation.

For the preparation of the powder coating materials it is possible to add auxiliaries and additives that are customary in powder coating technology, such as leveling agents, examples include polysilicones or acrylates, light stabilizers, examples being sterically hindered amines, or other auxiliaries, as described in U.S. Pat. No. 6,613,861, for example, in a total amount of from 0.05 to 5% by weight. Fillers and pigments, such as titanium dioxide, may be added in an amount of up to 50% by weight of the total composition.

Optionally it is possible for additional catalysts, such as are already known in polyurethane chemistry, to be present. These include primarily organometallic catalysts, such as dibutyltin dilaurate, or else tertiary amines, such as 1,4-diazabicyclo[2,2,2]octane, for example, in amounts that may be from 0.001 to 1% by weight.

All of the constituents for preparing a powder coating composition may be homogenized in suitable apparatus, such as in heatable kneading apparatus, for example, but are preferably homogenized by extrusion, in which case upper temperature limits of 120 to 130° C. are preferably not exceeded. After it has been cooled to room temperature and appropriately comminuted, the extruded mass may be ground to form the ready-to-spray powder. This powder may be applied to suitable substrates, which may be done by the known methods, including electrostatic powder spraying or fluidized-bed sintering, with our without electrostatic assistance, for example. Powder application is followed by heating of the coated workpieces for curing at a temperature from 120 to 220° C. for from 4 to 60 minutes, preferably from 120 to 180° C. for from 6 to 30 minutes.

The low-temperature-curing powder coating compositions may generally be cured at temperatures from 120 to 160° C. Their use not only allows savings in energy and (cure) time but also the coating of many temperature-sensitive substrates, which at temperatures of 180° C. or above may exhibit unwanted yellowing, decomposition and/or embrittlement. Besides metal, glass, wood, leather, plastics, and MDF board, certain aluminum substrates are also suitable for this application. In the case of the aluminum substrates too high a temperature load may occasionally lead to an unwanted change in crystal structure.

Low-temperature-curing powder coating compositions of the prior art have the problem, however, that the coating materials have cured before the film is able to flow properly. Severe leveling problems, such as severe orange-peel or textured surfaces, critically reduce the quality of the coatings. The polyaddition compounds of the invention that contain uretdione groups can be used in high-reactivity polyurethane powder coating compositions, and in this case the high-gloss or matt, light-stable and weather-stable powder coatings, cured at very low temperatures, exhibit good leveling.

The invention further provides for the use of the powder coating compositions of the invention to produce powder coatings, particularly on metal, plastic, glass, wood or leather substrates or other heat-resistant substrates.

Likewise provided by the invention are metal-coating compositions, particularly for automobile bodies, cycles and motorcycles, architectural components and household appliances, wood-coating compositions, glass-coating compositions, leather-coating compositions, and plastics-coating compositions, essentially comprising the polyurethane powder coating composition of the invention comprising the polyaddition compounds I containing uretdione groups in combination with at least one hydroxyl-containing polymer II, at least one catalyst III, if desired, at least one compound IV which is reactive toward acid groups, and, if desired, auxiliaries and additives.

The subject matter of the invention is illustrated below with reference to examples, which are not intended to further limit the claimed subject matter.

### EXAMPLES

A) Preparation of the Polyaddition Compound Containing Uretdione Groups

1. From Solvent

In a reactor, 230 g of dodecane-1,12-diol and 0.5 g of dibutyltin dilaurate were dissolved in 1 l of acetone. The solution was heated to 50° C. With vigorous stirring and under an inert gas atmosphere 470 g of IPDI uretdione were added. The reaction was monitored by titrimetric determination of NCO and was over after 2 hours. At that point the solvent was removed and the product was cooled and comminuted. It had a melting range of 89 to 92° C. and an NCO content of 11.4%.

2. Solventlessly

470 g of IPDI uretdione were fed at a temperature of 60 to 110° C. into the intake barrel section of a twin-screw extruder at the same time as a mixture of 230 g of dodecane-1,12-diol and 0.5 g of dibutyltin dilaurate was metered in with a temperature of 25 to 110° C.

The extruder employed was made up of ten barrel sections, of which five were heating zones. The setpoint temperatures of the five heating zones were situated between 50 and 180° C. and could be controlled individually. Regulation within the barrel sections took place by means of electrical heating and pneumatic cooling. The die element was heated by means of an oil thermostat. The rotational speed of the twin screws, which were fitted with conveying elements, was between 50 and 380 rpm.

The reaction product, obtained at a rate of from 10 to 130 kg/h, was cooled, comminuted, and bagged. It possessed a melting range of 89 to 92° C. and had an NCO content of 11.4%.

B) Polyurethane Powder Coating Materials

General Preparation Instructions

The ground products—polyaddition compound of the invention containing uretdione groups, polyester, acid scavenger, catalyst, leveling agent, and white pigment—were intimately mixed in an edge runner mill and then homogenized in an extruder at 80 to 140° C. On cooling, the extrudate was fractionated and was ground with a pinned disc mill to a particle size<100 μm. The powder produced in this way was applied to degreased, optionally pretreated iron panels using an electrostatic powder spraying unit at 60 kV, and the panels were baked in a forced-air drying oven at 150° C. for 30 minutes.

| Ingredients | Product description, manufacturer |
|---|---|
| A1 | polyaddition compound of the invention, |
| | uretdione content: 11.4% |
| VESTAGON BF 1320 | powder coating crosslinker, Degussa AG, |
| | Coatings & Colorants, uretdione content: 13.8% |
| CRELAN VP LS 2147 | powder coating crosslinker, Bayer AG, |
| | uretdione content: 12.8% |
| ALFTALAT AN 739 | OH polyester, OH number: 55-60; AN: 2-6; |
| | UCB |
| ARALDIT PT 810 | triglycidyl ether isocyanurate (TGIC), Vantico |
| KRONOS 2160 | titanium dioxide, Kronos |
| RESIFLOW PV 88 | leveling agent, Worlee-Chemie |
| TBAH | tetrabutylammonium hydroxide, Aldrich |

OH number: consumption in mg KOH/g polymer; AN: acid number, consumption in mg KOH/g polymer

Powder coating compositions (amounts in % by mass):

| | | ALFTALAT | | PT |
|---|---|---|---|---|
| Examples | Crosslinker | AN 739 | TBAH | 810 |
| 1 | 22.90 A1 | 43.85 | 0.75 | 1.50 |
| C1* | 20.08 VESTAGON BF 1320 | 46.56 | 0.79 | 1.50 |
| C2* | 21.14 CRELAN VP LS 2147 | 45.46 | 0.90 | 1.50 |

*noninventive, comparative examples

In addition, each of the formulations uses 30.0% by weight of KRONOS 2160, 1.0% by weight of RESIFLOW PV 88 and 1.5% by weight of ARALDIT PT 810.

Results of curing after 30 minutes at 150° C.:

| | Erichsen cupping | Ball impact direct/indirect | |
|---|---|---|---|
| Examples | [mm] | [inch · lb] | Leveling |
| 1 | >10.0 | >160/>160 | 6 |
| C1* | >10.0 | 100/70 | fine texture |
| C2* | >10.0 | >160/>160 | 4 |

Erichsen cupping to DIN 53 156
Ball impact to ASTM D 2794-93
Leveling to PCI (1 to 10, 1 very poor, 10 very good)

German application 10347901.5 filed on Oct. 15, 2003 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1. A polyurethane powder coating composition comprising:
I at least one solid polyaddition compound having uretdione groups, comprising reacted amounts of
A) from 40% to 90% by mass of at least one of an aliphatic, (cyclo)aliphatic or cycloaliphatic polyisocyanate component comprising
1. at least 40% by mass of at least one polyisocyanate compound having one or more uretdione groups and having an average functionality of at least 2.0, and
2. not more than 60% by mass of at least one diisocyanate compound or isocyanurate compound without uretdione groups;
B) from 60% to 10% by mass of dodecane- 1,12-diol; and
C) from 50% to 0% by mass of at least one further compound having at least one hydroxyl group;
wherein the polyaddition compound has a melting point of from 40 to 130° C., a free NCO content of less than 5% by weight, and a uretdione content of from 6 to 18% by weight;
II at least one hydroxyl-containing polymer having a melting point of from 40 to 130° C. and an OH number of between 20 and 200 mg KOH/g; and
III at least one catalyst selected from the group consisting of a metal acetylacetonate, a metal hydroxide, a metal alkoxide, and a quaternary ammonium salt of at least one of a hydroxide, fluoride or carboxylate;
wherein from 0.3 to 1 uretdione group of component I are present for each hydroxyl group of component II, and the catalyst III is present in an amount of from 0.001 to 3% by weight of the total amount of I and II.

2. The polyurethane powder coating composition as claimed in claim 1, wherein the solid polyaddition compound comprises reacted units of at least one of 1,6-diiso-cyanatohexane, 2-methylpentamethylene 1,5-diisocyanate, 2,2,4(2,4,4)-trimethylhexamethylene diisocyanate, 4,4′-diisocyanatodicyclohexylmethane, 1,3-and 1,4-diisocyanatocyclohexane, isophorone diisocyanate, diphenylmethane 2,4′-diisocyanate, diphenyl methane 4,4′-diisocyanate, xylylene diisocyanate, or 2,4-tolylene diisocyanate 2,6-tolylene diisocyanate.

3. The polyurethane powder coating composition as claimed in claim 1, wherein C) comprises at least one selected from the group consisting of a monool, a diol and a polyol having a molecular weight of at least 32.

4. The polyurethane powder coating composition as claimed in claim 1, wherein C) comprises at least one selected from the group consisting of methanol, ethanol, n-propanol, isopropanol, n-butanol, iso-butanol, sec-butanol, an isomeric pentanol, an isomeric hexanol, an isomeric octanol, an isomeric nonanol, n-decanol, n-dodecanol, n-tetradecanol, n-hexadecanol, n-octadecanol, cyclohexanol, an isomeric methylcyclohexanol, hydroxymethylcyclohexane, ethylene glycol, triethylene glycol, butane-1,4-diol, pentane-1,5-diol, hexane-1,6-diol, 3-methylpentane-1,5-diol, neopentyl glycol, 2,2,4(2,4,4)-trimethylhexanediol, neopentyl glycol hydroxypivalate, trimethylolpropane, ditrimethylolpropane, trimethylolethane, hexane-1,2,6-triol, butane-1,2,4-triol, tris(β-hydroxyethyl) isocyanurate, pentaerythritol, mannitol, sorbitol, a hydroxyl-containing polyester, a polycarbonate, a polycaprolactone, a polyether, a polythioether, a polyesteramide, a polyurethane and a polyacetal.

5. The polyurethane powder coating composition as claimed in claim 1, wherein the hydroxyl-containing polymer II comprises at least one of a polyester, a polyether, a polyacrylate, a polyurethane or a polycarbonate.

6. The polyurethane powder coating composition as claimed in claim 1, wherein further comprising one or more compounds reactive with a hydroxyl group IV is present in an amount of from 0.1 to 10% by weight based on the total weight of the composition.

7. The polyurethane powder coating composition as claimed in claim 6, wherein compound IV comprises at least one selected from the group consisting of an epoxy compound, a carbodiimide, a hydroxylalkylamide and a 2-oxazoline.

8. The polyurethane powder coating composition as claimed in claim 7, wherein compound IV comprises at least one selected from the group consisting of a pivalic acid glycidyl ester, a triglycidyl ether isocyanurate, a bis-phenol A resin, an isophorone diisocyanate, phenylenebisoxazoline, 2-methyl-2-oxazoline, 2-hydroxyethyl-2-oxazoline, 2-hydroxypropyl-2-oxazoline and 5-hydroxypentyl-2-oxazoline.

9. A process for preparing a polyurethane powder coating composition comprising
mixing the following components I-III in a heatable apparatus at a temperature of not greater than 130° C.,
I at least one solid polyaddition compound having uretdione groups, comprising reacted units of
A) from 40% to 90% by mass of at least one of an aliphatic, (cyclo)aliphatic or cycloaliphatic polyisocyanate component comprising
1. at least 40% by mass of at least one polyisocyanate compound having one or more uretdione groups and having an average functionality of at least 2.0, and
2. not more than 60% by mass of at least one diisocyanate compound or isocyanurate compound without uretdione groups;
B) from 60% to 10% by mass of dodecane-1,12-diol; and
C) from 50% to 0% by mass of at least one further compound having at least one hydroxyl group;
wherein the polyaddition compound has a melting point of from 40 to 130° C., a free NCO content of less than 5% by weight, and a uretdione content of from 6 to 18% by weight;
II at least one hydroxyl-containing polymer having a melting point of from 40 to 130° C. and an OH number of between 20 and 200 mg KOH/g; and
III at least one catalyst selected from the group consisting of a metal acetylacetonate, a metal hydroxide, a metal alkoxide, and a quaternary ammonium salt of at least one of a hydroxide, fluoride or carboxylate;
wherein from 0.3 to 1 uretdione group of component I are present for each hydroxyl group of component II, and the catalyst III is present in an amount of from 0.001 to 3% by weight of the total amount of I and II.

10. A method comprising
applying a polyurethane powder coating composition on a substrate to form a coating then
curing the coating to form a cured coating,
wherein the composition comprises
I at least one solid polyaddition compound having uretdione groups, comprising reacted amounts of
A) from 40% to 90% by mass of at least one of an aliphatic, (cyclo)aliphatic or cycloaliphatic polyisocyanate component comprising
1. at least 40% by mass of at least one polyisocyanate compound having one or more uretdione groups and having an average functionality of at least 2.0, and
2. not more than 60% by mass of at least one diisocyanate compound or isocyanurate compound without uretdione groups;
B) from 60% to 10% by mass of dodecane-1,12-diol; and
C) from 50% to 0% by mass of at least one further compound having at least one hydroxyl group;
wherein the polyaddition compound has a melting point of from 40 to 130° C., a free NCO content of less than 5% by weight, and a uretdione content of from 6 to 18% by weight;
II at least one hydroxyl-containing polymer having a melting point of from 40 to 130° C. and an OH number of between 20 and 200 mg KOH/g; and
III at least one catalyst selected from the group consisting of a metal acetylacetonate, a metal hydroxide, a metal alkoxide, and a quaternary ammonium salt of at least one of a hydroxide, fluoride or carboxylate;
wherein from 0.3 to 1 uretdione group of component I are present for each hydroxyl group of component II, and the catalyst III is present in an amount of from 0.001 to 3% by weight of the total amount of I and II.

11. A coated substrate comprising the cured composition of claim 1 on a surface of the substrate.

12. The method as claimed in claim 10, wherein the substrate is metal, plastic, wood, glass, or leather.

13. The process as claimed in claim 9, wherein the mixing is carried out at a temperature of no greater than 120° C.

14. A metal-coating composition comprising the composition of claim 1.

15. A wood-coating composition comprising the composition of claim 1.

16. A leather-coating composition comprising the composition of claim 1.

17. A plastic-coating composition comprising the composition of claim 1.

18. The polyurethane powder coating composition of claim 1, consisting essentially of I, II and III.

19. The polyurethane powder coating composition of claim 1, wherein I, II and III are present in an amount of greater than 50% by weight based on the total weight of the polyurethane powder coating composition.

20. The method as claimed in claim 10, wherein the curing is carried out at a temperature of from 120° C. to 160° C.

21. The polyurethane powder coating composition of claim 1, consisting essentially of I, II, and III.
